(19) United States
(12) Patent Application Publication
(10) Pub. No.: US 2025/0196460 A1
(43) Pub. Date: Jun. 19, 2025

(54) SINGLE FACE TUBE DIE-CUT AND SHEET PROCESS

(71) Applicant: WestRock Shared Services, LLC, Atlanta, GA (US)

(72) Inventor: Gregory P. MAGNELL, Vicksburg, MI (US)

(21) Appl. No.: 18/962,901

(22) Filed: Nov. 27, 2024

Related U.S. Application Data
(63) Continuation of application No. 17/575,557, filed on Jan. 13, 2022.
(60) Provisional application No. 63/137,038, filed on Jan. 13, 2021.

(51) Int. Cl. B31B 50/36; B31B 50/14; B31B 50/16; B31B 50/25; B31B 50/62; B31B 105/00; B31B 120/70

(52) U.S. Cl. CPC B31B 50/36; B31B 50/142; B31B 50/16; B31B 50/25; B31B 50/62; B31B 2105/00; B31B 2120/70

(57) ABSTRACT

A system comprises a corrugator single facer configured to receive a first web and a second web, to corrugate the first web and adhere the first web in a corrugated state to the second web in an uncorrugated state to form a single face corrugated web as output. The system also includes a folder gluer operatively connected to receive the single face corrugated web from the corrugated single facer. The folder gluer is configured to fold and adhere the single-face corrugated web into a tube.

### BACKGROUND

### 1. Field

The present disclosure relates to packaging, and more particularly to packaging for shipping such as in e-commerce.

### 2. Description of Related Art

Shipping needs for e-commerce include considerable volume of packaging used for shipping products. Multiple items can be grouped in a single order, where each individual product is already packaged or does not need its own package. However, in order to economize and ship the products together, they must be packaged together in a single shipping container. In other cases, a product such as a book may be shipped on its own, but it needs a shipping container to protect it during transit.

Fulfilment centers where products are placed in shipping containers match orders with one or more products by size to an appropriate shipping container. Given the large variation in order and products sizes, there must be a large variety of shipping containers in stock. Systems that provide custom-sized shipping packages on an order by order basis can considerably reduce the complications in fulfilment centers.

The conventional techniques have been considered satisfactory for their intended purpose. However, there is an ever present need for improved packaging materials, systems, and methods. This disclosure provides a solution for this need.

### SUMMARY

A system comprises a corrugator single facer configured to receive a first web and a second web, to corrugate the first web and adhere the first web in a corrugated state to the second web in an uncorrugated state to form a single face corrugated web as output. The system also includes a folder gluer operatively connected to receive the single face corrugated web from the corrugated single facer. The folder gluer is configured to fold and adhere the single-face corrugated web into a tube.

The system can include a rotary die cutting machine operatively connected between the corrugated single facer and the folder gluer to receive the single-face web from the corrugator single facer, and to cut a pattern in the single-face web upstream from the single face web entering the folder gluer. The rotary die cutting machine can include a plurality of tandem rotary dies for cutting the pattern into tandem portions of the single-face web. The system can be configured to form the single-face corrugated web into a tube without any break in the single-face corrugated web or tube formed therefrom. More specifically, the single-face web 101 can remain one continuous web from formation until it is finally cut into sheets.

The system can also include a rotary creaser/slitter machine operatively connected between the rotary die cutting machine and the folder gluer. The rotary creaser/slitter machine can be configured to receive the single-face web with the pattern from the rotary die cutting machine, to crease and/or slit the single-face web lengthwise, feeding the single face web into the folder gluer. The creaser/slitter can include a plurality of rotary creasers configured to form fold lines to facilitate folding the single-face web into a tube in the folder gluer and at least one rotary slitter configured to slit the single-face corrugated web into tandem portions.

The system can further include a rotary cut-off knife machine configured to cut one or more tandem tubes received from the folder gluer into sheets. The corrugator single-facer can include a first splicer for roll-to-roll splicing to make the first web continuous from multiple rolls of stock paper and a second splicer for roll-to-roll splicing to make the second web continuous from multiple rolls of stock paper.

The folder gluer can include a pair of contoured rails configured to roll lateral edges of the single-face web into overlapping position to form a tube. The pair of contoured rails can be a first pair of contoured rails for folding a first portion of the single-face web into a first tube. The folder gluer can also include a second pair of contoured rails for folding a second portion of the single face web into a second tube. The folder gluer can include an adhesive applicator configured to apply adhesive longitudinally along the web to join lateral edges of the single face web into a tube.

A method includes producing a continuous single-face corrugated web, and forming the continuous single-face corrugated web into a tube without any break in the single-face corrugated web or tube formed therefrom.

The method can also include at least one of the following, cutting a pattern in the single-face web upstream from the tube, cutting the pattern into tandem portions of the single-face web, creasing and/or slitting the single-face web lengthwise, folding the single-face web into a tube along the creases and/or slits, cutting one or more tandem tubes into sheets, applying adhesive longitudinally along the web and join lateral edges of the single face web into a tube, and/or performing the method for each of the tandem portions of the single-face web simultaneously.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic side view of an embodiment of a system constructed in accordance with the present disclosure, showing production of a single-face tube and sheet;

FIG. 2 is a schematic top down view of the system of FIG. 1, showing the tube production;

FIG. 3 is a schematic perspective view of the system of sheet of FIG. 1, showing a completed sheet; and

FIG. 4 is a schematic box diagram of a method in accordance with the present disclosure.

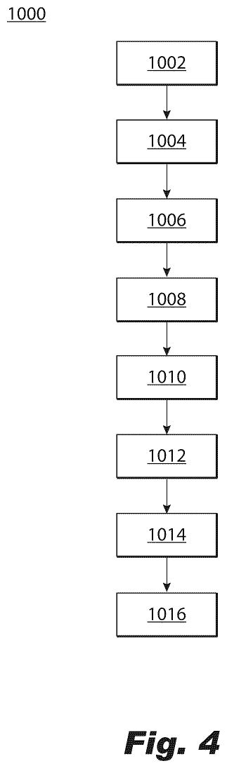

### DETAILED DESCRIPTION

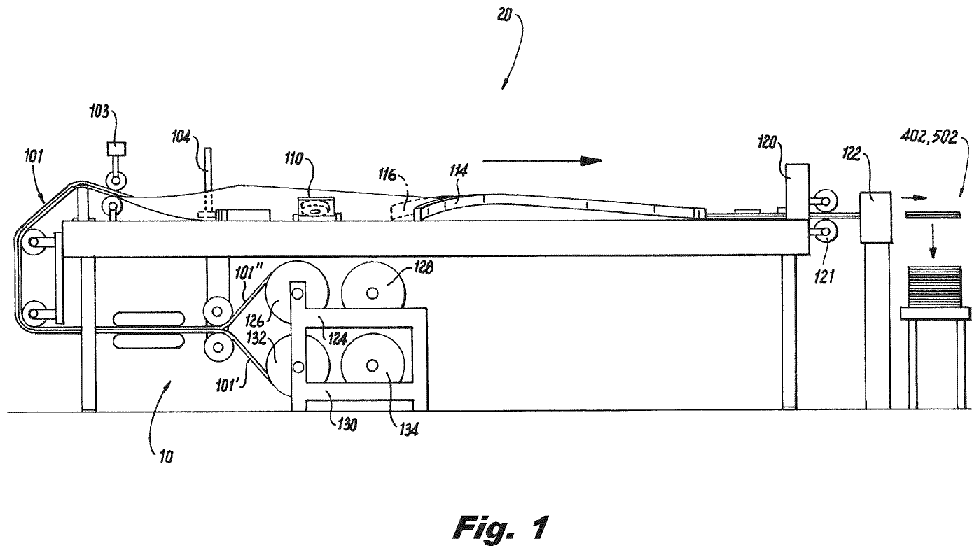

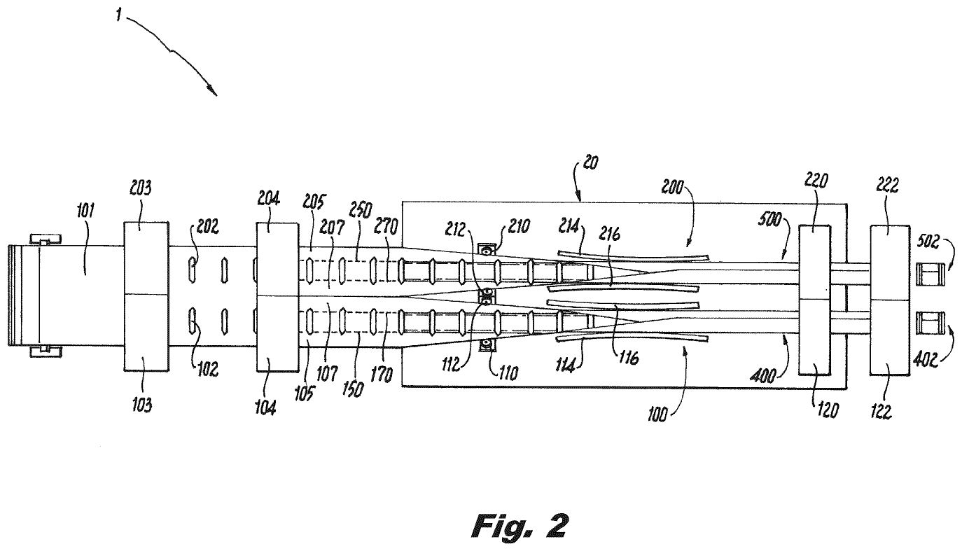

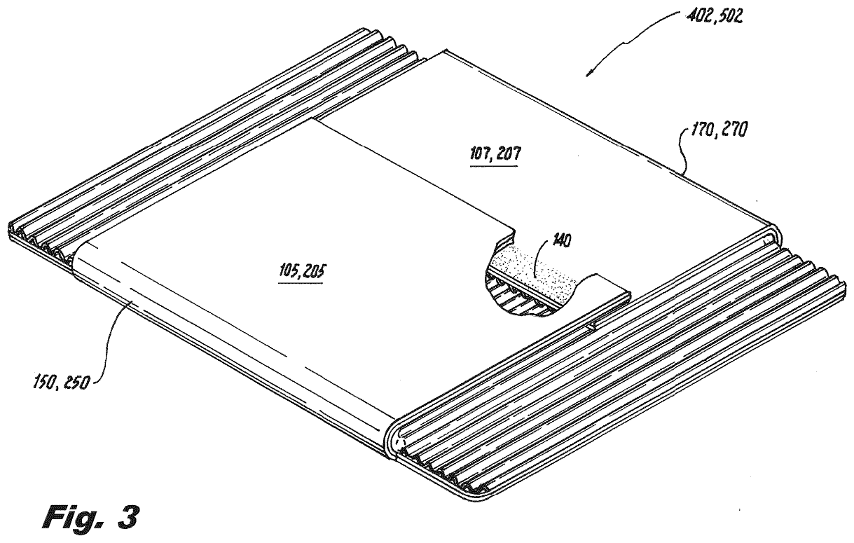

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-3, as will be described. The systems and methods described herein can be used to continuously produce a single-face tube.

A system 1 can comprises a corrugator single facer 10 configured to receive a first web 101′ and a second web 101″, to corrugate the first web 101′ and adhere the first web 101′ in a corrugated state to the second web 101″ in an uncorrugated state to form a single face corrugated web 101 as output. The system 1 can be configured to form the single-face corrugated web 101 into the tube 400 without any break in the single-face corrugated web 101 or tube 400 formed therefrom. For example, the system can continuously form tube 400 from the single face-corrugated web 101 from the initial rolls exiting the single facer 10 without any breaks or cuts in the paper until the final cutting process. As shown in FIG. 1, the corrugated first web 101′ can be laminated on a bottom face of the uncorrugated web 101″ so that when the single-face corrugated web 101 is flipped prior to entering the processing machinery described below, the corrugated side of the single-face corrugated web 101 will be face up and the resulting tube 400, 500 will have internal corrugation. However, it is also possible that the single-face corrugated web 101 can be formed so that when flipped, the uncorrugated portion of the single-face corrugated web 101 can be face up such that the resulting tube 400, 500 will have external corrugation.

The corrugator single-facer 10 can include a first splicer 124 for roll-to-roll splicing to make the first web 101′ continuous from multiple rolls of stock paper (e.g. rolls 126, 128 stocked in line with first web 101′) and a second splicer 130 for roll-to-roll splicing to make the second web 101″ continuous from multiple rolls of stock paper (e.g. rolls 132, 134 similar to that of first web 101′.). While FIG. 1 shows two rolls of stock paper for each of the first and second webs 101′, 101″, it should be appreciated by those skilled in the art that any number of rolls of stock paper can be included, and stock rolls may be added to the line during operation for continuous splicing and facing.

The system 1 can include a rotary die cutting machine 103 operatively connected between the corrugated single facer 10 and the folder gluer 20 to receive the single-face web 101 from the corrugator single facer 10. After receiving the single-face web 101, the rotary die cutting machine 103 can cut a pattern 102 (e.g. an elongated hexagon as shown) in the single-face web 101, where the rotary die cutting machine 103 is placed upstream from the single-face web 101 entering the folder gluer 20. The rotary die cutting machine 103 can include a plurality of tandem rotary dies (e.g. 103, 203) for cutting the pattern 102 into tandem portions 100, 200 of the single-face web 101.

The system 1 can also include a rotary creaser/slitter machine 104 operatively connected between the rotary die cutting machine 103 and the folder gluer 20 and mounted transversal to the flow of the single-face web 101 (e.g. direction D). The rotary creaser/slitter machine 104 can be configured to receive the single-face web 101 with the pattern 105 from the rotary die cutting machine 103, to crease and/or slit the single-face web 101 lengthwise, before feeding the single-face web 101 into the folder gluer 20. The rotary creaser/slitter 104, 204 can include a plurality of rotary creasers configured to form fold lines 150, 170, 250, 270 to facilitate folding the single-face web 101 into a tube in the folder gluer 20, and at least one rotary slitter to slit the single-face corrugated web 101 into tandem portions 100, 200. The rotary creaser/slitter machine 104 may be geared together with the rolls driving the movement of the single-face web 101, and the rolls of the rotary die cutting machine 103, however it is also possible each element may be driven independently.

The folder gluer 20 can include at least one pair of contoured rails (e.g. helical skis 114, 116) to guide each of the lateral edges 105, 107, 205, 207 upwards to roll fold the edges near 180 degrees about corresponding fold lines 150, 170, 250, 270 into an overlapping position to form the single-face web 101 into a non-glued partially flat tube. The lateral edges 105, 107, 205, 207 are not initially folded to a full 180 but the contoured rails so that there is space for adhesive 140 to be applied to the respective lateral edge receiving the adhesive 140. The pair of contoured rails can be a first pair (e.g. 114, 116) of contoured rails for folding a first portion 100 of the single-face web 101 into a first tube 400.

The folder gluer 20 can also include a second pair of contoured rails (e.g. 214, 216) for folding a second portion 200 of the single-face web 101 into a second tube 500 at the same time the first portion 100 is formed. The folder gluer 20 can include an adhesive applicator 120 configured to apply adhesive 140 longitudinally along the web 101 to join lateral edges 105, 107, 205, 207 of the single-face web 101 into a glued tube 400, 500. Because the folder gluer 20 can operate simultaneously for each of the tandem tubes, the system 1 can include a second adhesive applicator 220 for applying adhesive 140 to the second tube 500. To secure the adhesive 140, the system 1 can include a set of pressure rollers 121 to apply pressure to a top and bottom surfaces of the tube 400, 500 after application of adhesive 140, as shown in FIG. 1.

The system 1 can further include a rotary cut-off knife machine 122 configured to cut one or more tandem tubes 400, 500 received from the folder gluer 20 into sheets (e.g. sheet 402/502 as shown in FIG. 3). Like the rotary creaser/slitter machine 104, the rotary cut-off knife machine 122 may be geared together with the rolls driving the movement of the single-face web 101, and the rolls of the rotary die cutting machine 103, and the rolls driving the rotary creaser/slitter machine 104, however it is also possible each element, including the rotary cut-off knife machine 122, may be driven independently. The drive for the rotary cut-off knife machine 122 allows for a cut to be at a desired, predetermined, repeated interval, for example, every 20 inches, or any suitable interval.

Further, the rotary cut-off knife machine 122 can include a registration system (not shown, but it should be appreciated that the registration system may be within the rotary cut-off knife machine 122) that includes a photosensor and/or a vision camera that can detect the pattern 102, 202 that has been cut into the single-face web 101. The detection of this pattern 102, 202 can be used to time the operation of rotary cut-off knife machine 122. For example, the registration of the die-cut pattern 102, 202 allows rotary cut-off knife machine 122 drive to time and place a transversal cut at the same location as the die cut pattern 102, 202, or a specified offset from the die cut pattern, e.g. to allow for overhang or flaps such as shown in the sheeted tubes 402, 502 in FIG. 3.

A method includes producing 1000 a continuous single-face corrugated web 101, and forming 1002 the continuous single-face corrugated web 101 into a tube 400, 500 without any break in the single-face corrugated web 101 or tube 400, 500 formed therefrom until the tube 400, 500 is finally cut.

When forming 1002, the method can include cutting 1004 a pattern 102, 202 in the single-face web 101 upstream from the tube 400, 500. Cutting 1004 can include cutting the pattern 202, into tandem portions of the single-face web (e.g. for portions 100, 200). The method 1000 can include creasing and/or slitting 1006 the single-face web 101 lengthwise prior to feeding 1008 the single-face web into the folder gluer. Further, the method 1000 can include folding 1008 the single-face web 101 into a tube 400, 500 along the creases and/or slits (e.g. fold lines 150, 170, 250, 270). The method 1000 can also include cutting 1010 one or more tandem tubes 400, 500 into sheets. Applying adhesive 1012 longitudinally along the web 101 and joining 1014 lateral edges of the single-face web 101 into a tube 400, 500. Performing the method 1000 can include repeating 1016 the method 1000 for each of the tandem portions 100, 200 of the single-face web 101, or repeating 1016 the method 1000 simultaneously for each tandem portion 100, 200.

The methods and systems of the present disclosure, as described above and shown in the drawings, allow for improved packaging through continuously producing a single-face tube with an integrated die-cut feature. While the apparatus and methods of the subject disclosure have been shown and described, those skilled in the art will readily appreciate that changes and/or modifications may be made thereto without departing from the scope of the subject disclosure.

What is claimed is:

1. A system comprising:
a corrugator single facer configured to receive two webs, a first web in an uncorrugated state and a second web in the uncorrugated state, to corrugate the first web upon receipt and adhere the first web in a corrugated state to the second web in an uncorrugated state to form a continuous single face corrugated web as output;
a rotary a rotary die cutting machine connected to receive the continuous single-face web from the corrugated single facer and cut a pattern in the single-face web into tandem portions of the single-face web; and
a folder gluer operatively connected to receive the single face web from the corrugated single facer and simultaneously fold and adhere each of the portions of the tandem portions of the single-face web into a single-face corrugated tube.

2. The system as recited in claim 1, wherein the rotary die cutting machine is configured to cut the pattern in the single-face web upstream from the single face web entering the folder gluer.

3. The system as recited in claim 1, wherein the rotary die cutting machine includes a plurality of tandem rotary dies for cutting the pattern into the tandem portions of the single-face web.

4. The system as recited in claim 1, further comprising a rotary creaser/slitter machine operatively connected between the rotary die cutting machine and the folder gluer, wherein the rotary creaser/slitter machine is configured to receive the continuous single-face web with the pattern from the rotary die cutting machine, to crease and/or slit the single-face web lengthwise, feeding the single face web into the folder gluer.

5. The system as recited in claim 4, wherein the creaser/slitter machine includes a plurality of rotary creasers configured to form fold lines to facilitate folding the single-face web into a tube in the folder gluer and at least one rotary slitter configured to slit the single-face corrugated web into tandem portions.

6. The system as recited in claim 1, further comprising a rotary cut-off knife machine configured to cut one or more tandem tubes received from the folder gluer into sheets.

7. The system as recited in claim 1, wherein the corrugator single-facer includes a first splicer for roll-to-roll splicing to make the first web continuous from multiple rolls of stock paper and a second splicer for roll-to-roll splicing to make the second web continuous from multiple rolls of stock paper.

8. The system as recited in claim 1, wherein the folder gluer includes a pair of contoured rails configured to roll lateral edges of the single-face web into overlapping position to form a tube.

9. The system as recited in claim 1, wherein the folder gluer includes a pair of contoured rails having a first pair of contoured rails is configured to fold a first portion of the single-face web into a first tube, and further comprising a second pair of contoured rails configured to simultaneously fold a second portion of the single face web into a second tube.

10. The system as recited in claim 1, wherein the folder gluer includes an adhesive applicator configured to apply adhesive longitudinally along the web to join lateral edges of the single face web into a glued tube.

11. (canceled)

12. A method comprising:
producing a continuous single-face corrugated web;
receiving the continuous single-face web and cutting a pattern in a single-face upstream into tandem portions of the single-face web; and
folding and adhering each of the portions of the tandem portions of the single-face web simultaneously to form a single-face corrugated tube.

13. The method as recited in claim 12, wherein the cutting comprises cutting the pattern in the single-face web upstream from the tube.

14. (canceled)

15. The method as recited in claim 12, further comprising creasing and/or slitting the single-face web lengthwise prior to feeding the single-face web into a folder gluer.

16. The method as recited in claim 15, further comprising folding the single-face web into the tube along the creases and/or slits.

17. The method as recited in claim 16, wherein folding includes roll lateral edges of the single-face web into overlapping position to form the tube

18. The method as recited in claim 16, further comprising cutting one or more tandem tubes into sheets.

19. The method as recited in claim 18, further comprising applying adhesive longitudinally along the web and join lateral edges of the single face web into the tube.

20. The method as recited in claim 12, further comprising performing the method for each of the tandem portions of the single-face web simultaneously.

21. The system of claim 9, wherein the second pair of contoured rails is configured to fold the second portion of the single face web at a same time the first portion of the single face web is folded.

22. The system of claim 10, wherein the folder gluer further includes a second adhesive applicator configured to apply adhesive longitudinally along the continuous single face web to join lateral edges of the continuous single face web into a second glued tube, wherein the second adhesive applicator operates simultaneously as the first adhesive applicator.
